(19) United States
(12) Patent Application Publication
(10) Pub. No.: US 2025/0178565 A1
(43) Pub. Date: Jun. 5, 2025

(54) METHOD AND APPARATUS FOR VEHICULAR SECURITY BEHAVIORAL LAYER

(71) Applicant: Harman International Industries, Incorporated, Stamford, CT (US)

(72) Inventors: Asadullah Ansari, Bangalore (IN); Sharath Yadav Doddamane Hemantharaja, Chitradurga (IN)

(21) Appl. No.: 18/843,200

(22) PCT Filed: Mar. 1, 2022
(86) PCT No.: PCT/US2022/070904

§ 371 Date: Aug. 30, 2024

(51) Int. Cl. B60R 25/30; B60R 25/10; B60R 25/20; B60R 25/24; H04W 12/121

(52) U.S. Cl. CPC B60R 25/30; B60R 25/10; B60R 25/209; B60R 25/245; H04W 12/121; B60R 2325/105; B60R 2325/108

(57) ABSTRACT

Methods and systems are described for a behavioral security layer for a remote keyless system of a vehicle, such as a remote keyless entry (RKE) system or a remote keyless ignition (RKI) system. An embodiment of the method may include processing a transmission for an operation of the remote keyless system of the vehicle, determining whether the transmission is associated with behavior of a legitimate user of the vehicle, using the behavioral security layer; and performing an action based on a determination that the transmission is not associated with behavior of a legitimate user of the vehicle.

### FIELD

The disclosure relates to behavioral security layers for remote keyless systems for vehicles (such as remote keyless entry systems and remote keyless ignition systems).

### BACKGROUND

Embedded systems of some modern vehicles may be connected to various decentralized services such as multimedia servers, voice command and speech recognition servers, localization and Global Navigation Satellite System (GNSS) servers such as Global Positioning System (GPS) servers, and so on. Cyber security of electronic control units (ECUs) handling sensitive vehicle parts (e.g., breaks, engine, and so on) can be compromised through such connections. One method for improving security of vehicle ECUs includes preserving the integrity of the interior of a vehicle, e.g., ensuring that an intruder has no physical access to potential attack vectors (such as the multimedia radio system). Therefore, it is desirable for related technologies involved in opening and/or closing a vehicle to include adequate security functions.

Remote keyless systems may include remote keyless entry (RKE) systems and/or remote keyless ignition (RKI) systems. RKE systems are successors to the traditional method of opening car doors by inserting physical keys. Keys with RKE capabilities allow key-holders to remotely lock and unlock car doors, and/or deactivate or activate (e.g., turn off or turn on) an antitheft alarm. RKI systems may allow key-holders to remotely start or stop an engine of the vehicle. In various embodiments, a remote keyless system may include both RKE and RKI system capabilities.

A remote keyless system may include two units collectively used to access a vehicle. The first unit, a customer identification device (CID), may be a handheld device carried by a user. For example, a CID may be a key fob. The second unit may be a receiver located inside the vehicle. Communication between the vehicle receiver and the CID may be established via a radio frequency (RF) or an infrared (IR) link.

Protection of a remote keyless system is desired to protect digital infrastructure. For example, when the remote keyless system includes an RKE system, in-vehicle components may be directly exposed to intruders if the remote keyless system is compromised. Some embodiments of conventional security systems used to protect remote keyless systems may include a cryptography-based security system, possibly with multiple cryptographic layers, for digital wireless entry into a vehicle. Cryptographic methods may include a fixed code technique, a rolling code technique, and a challenge-response technique. The above-described security solutions provide a mode of protection of a wireless link between the vehicle and a CID. These solutions rely on cryptographic methods for protecting the remote keyless systems by employing a variety of solutions in both the CID and the vehicle. A level of security in vehicles with conventional cryptographic security systems is dependent on a strength of cryptographic identifiers (IDs) or key lengths.

One measure of how secure a vehicle is may be the number of layers in the vehicle's security system, such as the number of layers of cryptographic operations in the vehicle's security system. Even so, cryptographic operations may be vulnerable to various attacks, including scan attacks, playback attacks, two-thief attacks, challenge forward prediction attacks, and/or dictionary attacks. Another threat to remote keyless systems are on-board diagnostic (OBD) key programmers. Increasing the number of security layers in a vehicle's security system may increase the vehicle's security level. However, since methods for cryptographic attacks may already be known, the mere layering of multiple cryptographic security layers may simply increase the time needed for an intruder to access the remote keyless system and enter the vehicle.

### SUMMARY

Disclosed herein are methods and mechanisms for behavioral security methods which may be used in addition to or as an alternative to cryptographic security methods to increase security of a remote keyless system of a vehicle. A behavioral-analytics-based security layer may use a trained artificial intelligence (AI) model to analyze behaviors of an individual attempting to access or use a vehicle (e.g., via a remote keyless system) and determine if the individual is a legitimate user or an intruder. Following determination of an identity of the individual (e.g., a legitimate user or an intruder), the behavioral analytics-based security layer may perform an action based on whether the individual is determined to be a legitimate user or an intruder.

A method for a behavioral security layer may include processing a transmission (e.g., including user behaviors) using a trained AI model to determine whether the transmission is associated with behavior of a legitimate user, and performing an action based on a determination that the transmission is not associated with behavior of a legitimate user (which may occur in instances of intrusion). Additionally, or alternatively, a method for the behavioral security layer may include receiving the transmission, analyzing user behavior included in the transmission using the trained AI model, and performing an action based on detection of an anomaly in user behavior during analysis (e.g., detection of anomalous behavior compared to legitimate user behavior).

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The disclosure may be better understood from reading the following description of non-limiting embodiments, with reference to the attached drawings, wherein below:

FIG. 1A shows a schematic of layers of a security system for accessing a remote keyless system of a vehicle, in accordance with one or more embodiments of the present disclosure;

FIG. 1B shows a method for accessing the security system of FIG. 1A, in accordance with one or more embodiments of the present disclosure;

FIG. 2 shows a schematic of a behavioral security layer, in accordance with one or more embodiments of the present disclosure;

FIG. 3 shows a method for training an AI model of the behavioral security layer of FIG. 2, in accordance with one or more embodiments of the present disclosure;

FIG. 4 shows a method for using a trained AI model of the behavioral security layer, in accordance with one or more embodiments of the present disclosure;

FIG. 5 shows a method for performing an action based on a determination that a transmission for a remote keyless system is not associated with behavior of a legitimate user, in accordance with one or more embodiments of the present disclosure;

FIG. 6 shows a method for performing an action based on detection of anomalies in the behavior of an individual interacting with a remote keyless system, in accordance with one or more embodiments of the present disclosure;

FIG. 7 shows an example partial view of one type of environment for a vehicle, in accordance with one or more embodiments of the present disclosure; and

FIG. 8 shows a block diagram of an in-vehicle computing system of FIG. 7, in accordance with one or more embodiments of the present disclosure.

### DETAILED DESCRIPTION

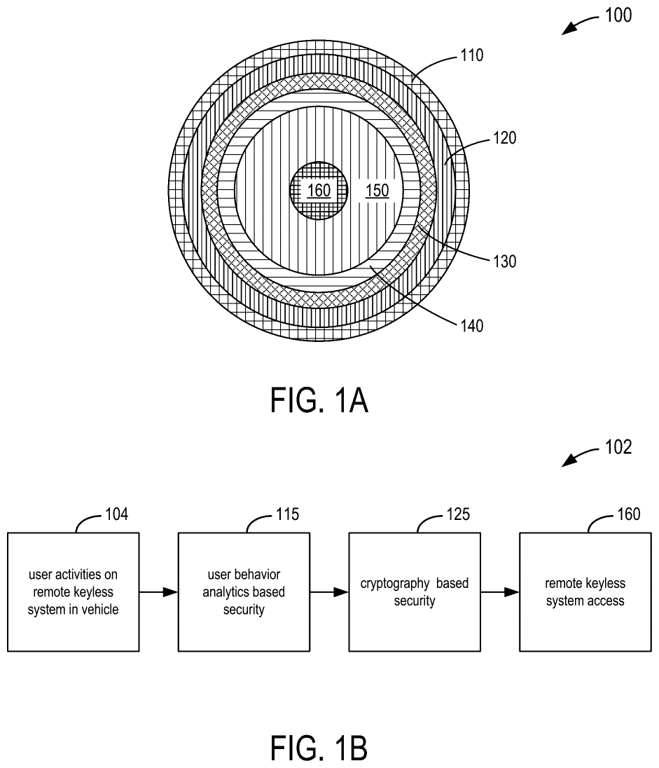

A vehicle with a remote keyless system, which may include remote keyless entry and remote keyless ignition capabilities, may have a multi-layered security system to assist in preventing intruders from accessing an interior of the vehicle. FIG. 1A shows a schematic of a multi-layered security system for accessing a remote keyless system of a vehicle. The multi-layered security system may include a behavioral security layer, and may also include at least one cryptographic security layer. When positioned as a first security layer, the behavioral security layer may process various parameters associated with an attempted interaction with the remote keyless system and perform an action based on identification of the interaction as being associated with a legitimate user or as being associated with an intruder. The action may include allowing the individual attempting to interact with the remote keyless system to access the one or more cryptography-based security layers and the remote keyless system, as shown in FIG. 1B.

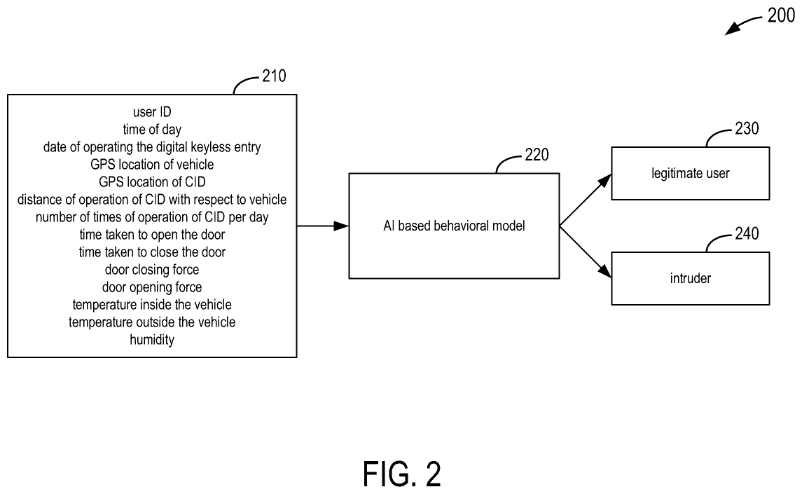

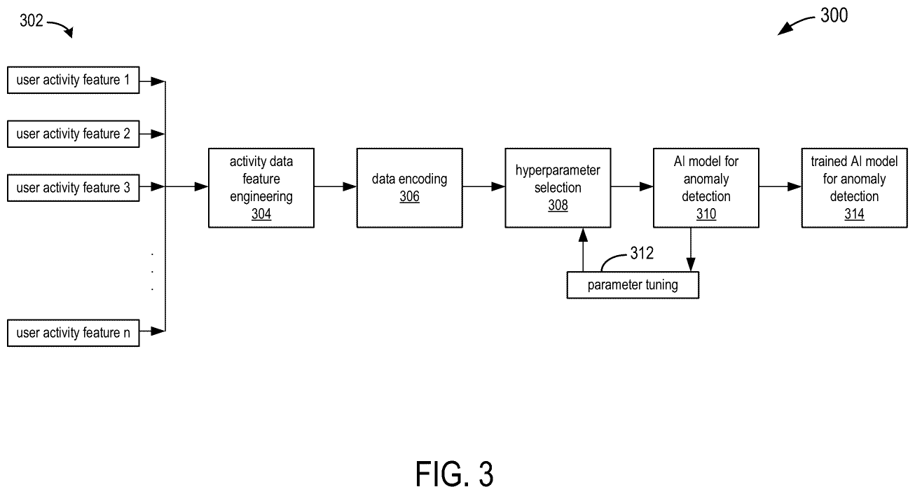

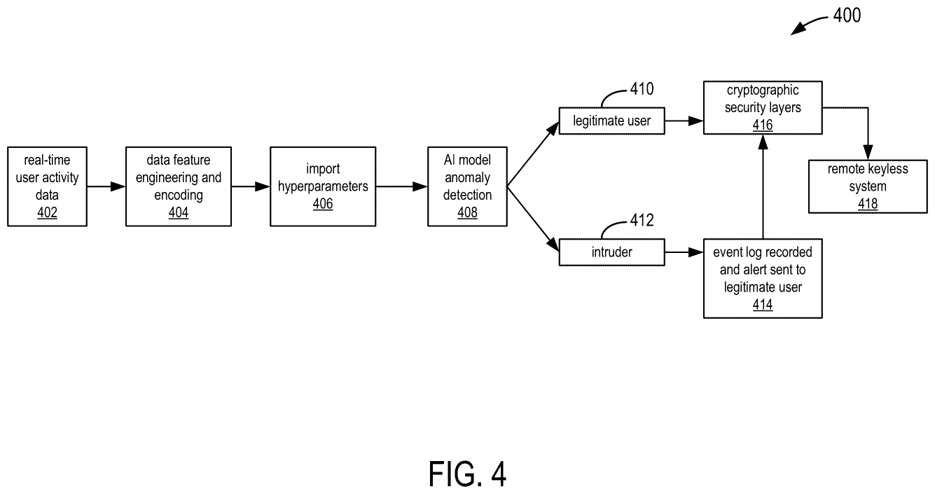

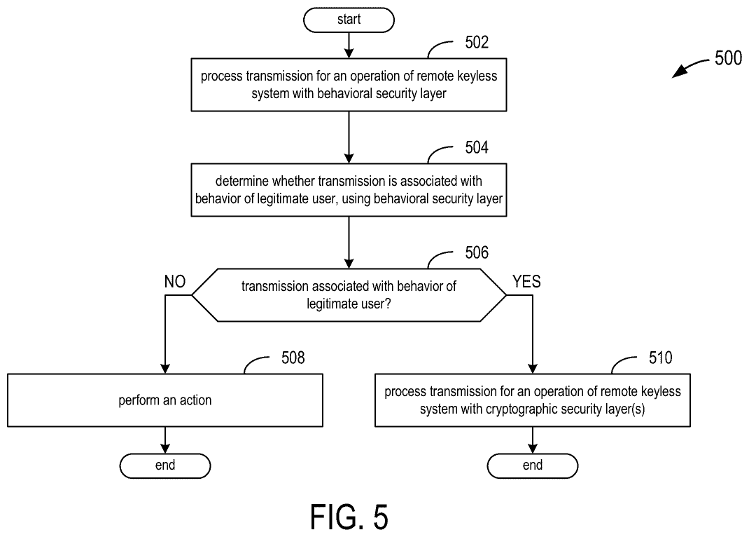

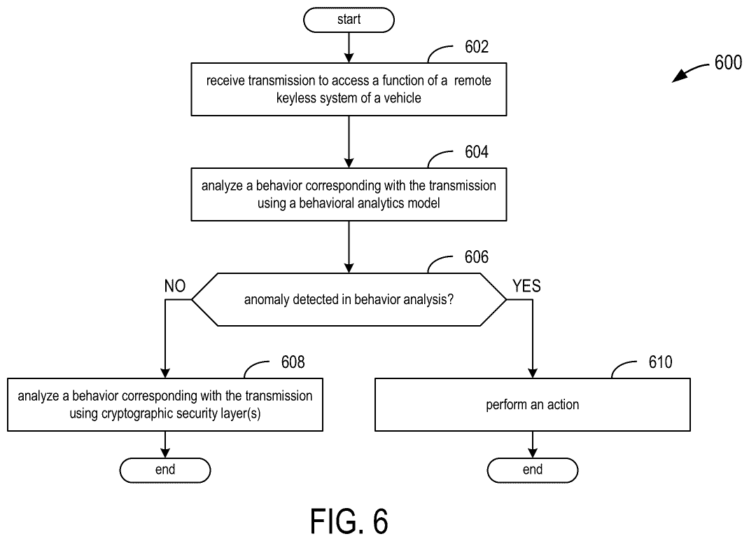

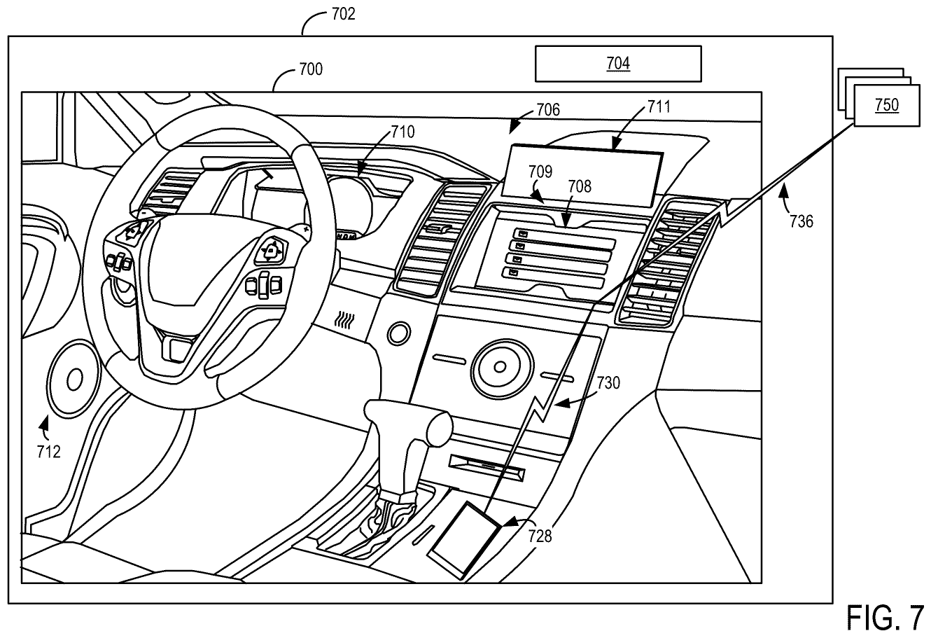

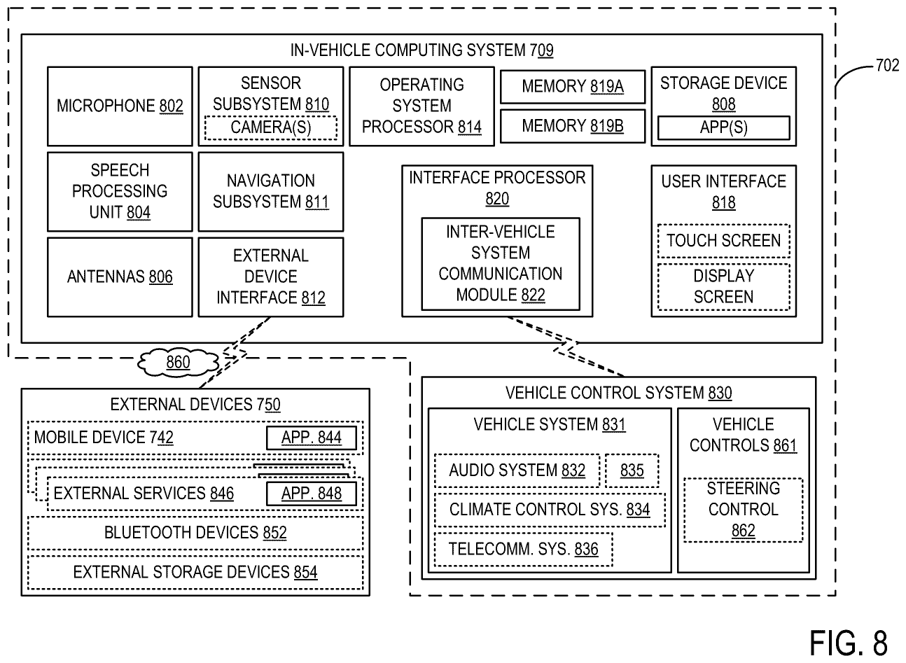

As shown in FIG. 2, the behavioral security layer includes an AI model for processing a transmission, including parameters associated with user behaviors (e.g., user activity data) pertaining to the transmission. The AI model may be trained according to a training method shown in FIG. 3. The behavioral security layer, including the trained AI model, may be used according to a method, shown in FIG. 4, for identifying an individual attempting to interact with the remote keyless system as a legitimate user or an intruder based on user activity data, and performing a corresponding action. The action may be performed based on determination that a transmission associated with the individual is not associated with behavior of a legitimate user, as shown in FIG. 5, or may be performed based on detection of anomalies in user behavior, as shown in FIG. 6. FIG. 7 shows an example partial view of one type of environment for a vehicle in which the multi-layered security system including a behavioral security layer is implemented, and FIG. 8 shows a block diagram of an in-vehicle computing system of FIG. 7.

The behavioral security layer thus uses behavioral analytics to detect entry, or attempted entry, of intruders into the vehicle. The AI model may be trained on legitimate user activity data collected by the behavioral security layer to identify complex and/or complicated patterns in the behaviors of legitimate users for the given vehicle. Parameters of the user activity data may reflect user behaviors. Behaviors other than those identified as legitimate user behaviors by the AI model may be considered illegitimate behaviors, which might indicate an attempted access by an intruder. For example, intruders may place jammers to block RF communication links, may record communication messages between the vehicle and the CID, may send their own code word to open a vehicle door, and so on. However, the behaviors of intruders attempting to enter the vehicle by illegitimate means may demonstrate their own patterns of operation, which may be distinguished from behaviors of legitimate users. Thus, intruder behavior may be detected using the trained behavioral AI model, and actions may then be taken (e.g., to prevent further access to the remote keyless system).

For example, a transmission for a remote keyless system may be received by a vehicle, and various parameters associated with the transmission may be analyzed to determine whether user behavior associated with the transmission is legitimate (e.g., behavior of a legitimate user) or illegitimate (e.g., behavior of an intruder). In various embodiments, the transmission may include one or more wireless transmissions compliant with a protocol for a remote keyless system. If the transmission is identified as demonstrating behaviors associated with those of an intruder, the parameters may be recorded (e.g., logged) and a previously identified legitimate user may be alerted to intruder entry. In some embodiments, an intruder may be allowed access to further security layers, such as cryptographic security layers, while in other embodiments an intruder may be blocked from further accessing the remote keyless system. If the transmission is identified as having behaviors associated with those of a legitimate user, the legitimate user may be allowed access to further security layers, such as cryptographic security layers. In this way, addition of a behavioral analytics-based security layer which uses an AI model to differentiate between legitimate users and intruders may increase security of the remote keyless system of the vehicle.

As briefly described above, the behavioral security layer may be implemented as an additional layer of an existing multi-layer security system for a vehicle. FIG. 1A shows a multi-layer security system 100 including a first layer 110, a second layer 120, a third layer 130, a fourth layer 140, and a fifth layer 150. A core remote keyless system 160 may be secured by each of first layer 110, second layer 120, third layer 130, fourth layer 140, and fifth layer 150.

The behavioral security layer may be implemented as an additional security layer (e.g., a layer n) on top of cryptography-based (or other types of) security layers (e.g., a layer n-1, a layer n-2, and so on). For example, in various embodiments, first layer 110 may be a behavioral security layer, and second layer 120, third layer 130, fourth layer 140, and fifth layer 150 may be cryptographic security layers. The behavioral analytics layer may therefore be a first layer of security accessed by a user, who may or may not be a legitimate user.

In other embodiments, the behavioral security layer may be integrated between security layers (e.g., cryptographic or other). For example, first layer 110 may be a cryptographic security layer, second layer 120 may be the behavioral security layer, and third layer 130, fourth layer 140, and fifth layer 150 may be cryptographic security layers. In various embodiments, any number of layers may precede and/or follow the behavioral security layer, and the number of layers on either side of the behavioral security layer may or may not be equal.

In some embodiments, the behavioral security layer may comprise a single-layer security system. For example, the behavioral security layer may be used independent of cryptographic layers or other types of security layers for a remote keyless system. For example, a single-layer security system may be used for systems for which less security is desired than for a remote keyless system, such as for an internal vehicle component. A single behavioral security layer may be implemented in addition to a multi-layer security system, such that the multi-layer security system, including at least one behavioral security layer and at least one cryptographic or other type of security layer, secures the remote keyless system and the single behavioral security layer secures the internal vehicle component.

As further described in relation to FIGS. 1B-6, the behavioral security layer may be implemented as a first security layer of a multi-layered security system for a vehicle. FIG. 1B shows a high-level method 102 for implementing the behavioral security layer as the first security layer, followed by at least one cryptographic security layer. (Elements of FIG. 1B which are associated with those described in relation to FIG. 1A are similarly numbered.)

When a user, who may or may not be a legitimate user, attempts to access the vehicle, such as via the remote keyless system, user activity data 104 may be provided to a behavioral security layer 115 (e.g., first layer 110). User activity data 104 may include various parameters associated with user behavior, such as transmissions related to an attempted keyless entry to the vehicle. Such transmissions may be generated by and/or sent from the CID, and may be received by and/or processed by one or more devices of the vehicle (e.g., a vehicle receiver). Values for the various parameters associated with a given transmission may then establish user behaviors used to train the behavioral security layer.

Behavioral security layer 115, as further described in relation to FIGS. 2-6, may include an AI model trained for anomaly detection. The AI model may analyze user activity data 104 (e.g., by analyzing parameters associated with user behavior) and may determine whether the user is a legitimate user or an intruder, for example based on detection of anomalous behavior. Different actions may be performed by behavioral security layer 115 depending on whether the user is identified as a legitimate user or as an intruder. Such actions are further described in relation to FIGS. 4-6. The user may proceed further through various cryptography-based security layers 125 (such as a layer n-1, a layer n-2, and so on), as further described in relation to FIGS. 4-6. Cryptography-based security layers 125 may allow the user to access remote keyless system 160, thus allowing the user to unlock, open, and/or otherwise access the vehicle.

FIG. 2 illustrates a high-level process 200 of the behavioral security layer. As briefly described above, the behavioral security layer includes a trained anomaly detection AI model, e.g., an AI based behavioral model 220, which may differentiate between behaviors of a legitimate user 230, such as an owner and/or operator of the vehicle, and an intruder 240. Once the anomaly detection AI model is trained, the AI model may be used each time a user, who may or may not be a legitimate user, attempts to access the remote keyless system.

For example, when a user attempts to access a vehicle having a behavioral security layer, user activity data (e.g., user activity data 104) including a plurality of user behavioral parameters 210 are transmitted to the vehicle and input into AI based behavioral model 220 (e.g., the trained anomaly detection AI model), which analyzes the user activity data to determine if the user exhibits behaviors of legitimate user 230 or behaviors of intruder 240. In various embodiments, vehicular parameters and/or non-vehicular parameters may be considered.

Various user behavioral parameters 210 may include a number of factors for accessing and operating the remote keyless system for vehicles, such as: a time of day (e.g., of the corresponding transmission); a date of operation (e.g., of the corresponding transmission); a location of the vehicle (e.g., a GNSS location); a distance between the vehicle and a CID which transmitted the transmission; a number of times per day of operation of the CID; a time taken to open a door of the vehicle; a time taken to close the door; a force of opening the door; a force of closing the door; a temperature inside the vehicle; a temperature outside the vehicle; and a humidity. These parameters describe behaviors of the user operating the remote keyless system. Modeling of legitimate user behaviors are quantified using these parameters. Various numbers of user behavioral parameters 210 may be used to determine if the user exhibits behaviors of a legitimate user or behaviors of an intruder. For example, at least a predetermined number of the user behavioral parameters listed above may be used, or all of the user behavioral parameters listed above may be used. In various embodiments, the user behavioral parameters used may include parameters other than those listed above. Further detail regarding collecting user activity data including user behavioral parameters, selecting and training the AI model, and using a trained AI model to identify legitimate users and intruders based on user behavior is described in relation to FIGS. 3-6.

FIG. 3 shows a method for training an AI model of a behavioral security layer. In various embodiments, the AI model may be substantially similar to AI based behavioral model 220. The behavioral security layer may include deep learning-based anomaly detection modeling. The vehicle may gather user activity data and/or generate a dataset used to train an anomaly detection AI model to learn user behaviors and differentiate between behaviors of a legitimate user and behaviors of an intruder.

Training of the behavioral security layer may occur over a training period in which user activity data (e.g., including various user behavioral parameters) may be collected from the vehicle and a CID. The training period may be any duration of time in which a sufficient amount of user activity data is collected (e.g., one week, three months, six months, and so on). A sufficient amount of data may be an amount of data from which anomalies in user behavior (e.g., anomalous behavior compared to legitimate user behavior) may be detected. Data collection may end prior to completion of the training period if a sufficient amount of data is collected which may be used to train the anomaly detection AI model. In further embodiments, user activity data may be collected for a predetermined number of access attempts (for example, fifty uses of the remote keyless system, three hundred uses of the remote keyless system, or a thousand uses of the remote keyless system). For such embodiments, the predetermined number of access attempts may be configurable.

During the training period, user activity data may be transmitted from the CID to the vehicle for each use of the remote keyless system. For example, a single user or multiple users may attempt to access the remote keyless system during the training period, using any number of CIDs that may be provisioned for use with the vehicle (e.g., by the vehicle's manufacturer). User activity data may include fourteen parameters: thirteen user behavioral parameters and an assigned user ID. The user ID may include a numerical ID, a user name, or other identifying label. The user ID may be different for each user of the remote keyless system, however the identity of any particular user may be determined, or the user ID may be different for each CID provisioned for use with the vehicle. In some embodiments, the user ID may be sourced from and/or used for vehicle systems other than the remote keyless system. Accordingly, for some embodiments, the user ID may be based on biometrics or other user activities (from, e.g., pre-existing mechanisms for identifying individual users). Additionally, or alternatively, in some embodiments, the user ID may be different for each CID, such as when a vehicle may be accessed by multiple CIDs, each belonging to a different user.

User activity data (e.g., user behavioral parameters and user IDs) collected during the training period may include user behavioral parameters 210, as shown in FIG. 2. User behavioral data may further include additional user behavioral parameters and/or alternative user behavioral parameters other than those listed herein. The aforementioned user activity data, including user behavioral parameters and user ID, may be collected for each instance where the remote keyless system is accessed. A different user ID and set of user behavioral parameters may be recorded for each use of the remote keyless system. A dataset may be generated from all user activity data collected during the training period.

Training of the AI model may implicitly include the incorporation of user behavioral parameters associated with multiple user IDs. The dataset generated during the training period may accordingly incorporate user behavioral parameters corresponding with multiple user IDs, which may correspond with one or more legitimate users and/or one or more CIDs.

A new set of user behavioral parameters may be generated for each use of a remote keyless system, resulting in hundreds of different sets of user activity data generated over the training period. For a vehicle which has two users, at the end of the training period, the trained model may recognize user activity data, including user behavioral parameters and user IDs, associated with one or more legitimate users and/or one or more CIDs as being legitimate.

As shown at a part 302 of FIG. 3, each of the user behavioral parameters in a user activity data set may become a user activity feature of the dataset. For example, user activity feature 1 may be a time of day, user activity feature 2 may be a date of operating the remote keyless system, user activity feature 3 may be a GNSS location of the vehicle, and so on through n number of user activity features. The dataset may then include a series of data points for each user activity feature. Accordingly, the dataset may include a series of values for a set of user activity features that respectively correspond with the set of user behavioral parameters. In various embodiments, user activity features may be statistically analyzed to identify patterns and/or variations associated within the dataset.

At a part 304, in some embodiments, a user activity feature set (e.g., user activity feature 1, user activity feature 2, and so on) may be selected and feature engineering may be performed. Feature engineering may include transforming features of the user activity feature set from raw data to data which may be more suitable for use in training the AI model. In some embodiments, existing user activity features may be transformed (e.g., by scaling). For some embodiments, new features may be created on the basis of existing user activity features (e.g., by combining user activity features). In some embodiments, some user activity features may be removed from the user activity feature set. In other words, feature engineering may facilitate the tuning of the user activity feature for the training of the AI model.

Following feature engineering, an anomaly detection neural network (e.g., an AI model) may be selected based on available data. For example, the anomaly detection neural network may be selected based on user activity features of the user activity feature set. If a number of features which may have a sufficient number of data points is less than a threshold number of features, a first anomaly detection neural network may be selected over a second anomaly detection neural network. The threshold number of features may be thirteen features, as described above in FIG. 2. An auto-encoder artificial neural network may be selected as the AI model when thirteen features have been identified. Other models may be selected for different embodiments based on available data.

At a part 306, feature engineered user activity feature sets are encoded. For example, it may be determined that user activity feature sets represent behavior associated with legitimate users and thus, user activity feature sets may be further transformed into a form more useable by the AI model.

At a part 308, hyperparameters may be selected which may be used to train the selected AI model. Selected hyperparameters may correspond with the selected AI model and may be used to control training of the selected model. Hyperparameters may include an amount of data, a batch size, a rate of learning, and so on. Initially, values for the hyperparameters may be randomly selected. A number and type of hyperparameters may be fixed for each implementation of the behavioral analytics model (e.g., in different vehicles). In various embodiments, part 306 may occur either before or after part 308.

At a part 310, encoded feature sets, and selected hyperparameters, may be input into a selected AI model for anomaly detection to train the AI model. Training may include tuning parameters of the AI model, as shown at a part 312, to train the AI model to correctly identify legitimate users based on user activity data (e.g., user behavioral parameters). For example, adjusting AI model parameters may include increasing or decreasing at least one weight and/or bias of the AI model. The behavioral security layer may thus be trained by adjusting AI model parameters until a minimum error is reached. In some embodiments, the minimum error may be 5% (e.g., 5% of legitimate users are identified as intruders, or vice versa), or 10%, or another suitable value.

Once the minimum error is attained, hyperparameters may be tuned and/or adjusted to select a set of hyperparameters for the AI model for which the behavioral security layer may operate with an error as close as possible to minimum error. For example, a number and a type of hyperparameters may be fixed across implementations of the behavioral security layer in different vehicles. Weights and biases of each AI model may vary among vehicles, as the AI model may be independently trained based on users for each vehicle.

At a part 314, a trained AI model for anomaly detection (which may be referred to herein as an AI model) may thus be prepared for detecting anomalous behavior in user activity data using the remote keyless system in a respective vehicle. In some embodiments, since user behavioral parameters may include personal data, training of the AI model may be done on the vehicle itself for privacy concerns. For some embodiments, training of the AI model may be performed on a cloud network to which the vehicle is communicably connected.

FIG. 4 shows a method 400 for using a trained AI model of the behavioral security layer. The AI model may be trained according to a method substantially similar to method 300 of FIG. 3. Method 400 may be implemented following the training period, in which the dataset of legitimate user activity data is generated.

At a part 402, when a user who may or may not be a legitimate user attempts to access the remote keyless system of the vehicle, user activity data is collected in real-time. User activity data may comprise user behavioral parameters including a user ID, as described in relation to FIGS. 2-3. A selection of user behavioral parameters such as those described above may be collected. In some embodiments, the selection may include parameters substantially similar to those of user behavioral parameters 210, as discussed above in relation to FIG. 2. Alternatively, at least a predetermined number of user behavioral parameters 210, as discussed above, may be collected.

At a part 404, collected user activity data may be processed, which may include feature engineering and/or data encoding. Featuring engineering and data encoding of collected user activity data may be performed in a manner similar to the feature engineering and data encoding of user activity features as described in relation to FIG. 3. Collected user activity data may thus be transformed from raw data into data which may be used by the trained AI model for detection of anomalous behavior.

At a part 406, hyperparameters may be imported to be used with the AI model for anomaly detection. For example, hyperparameters determined during AI model training (e.g., as described in relation to FIG. 3) may be tuned such that the AI model returns the minimum error. Importing these hyperparameters to be used with collected user activity data may assist in determining whether collected user activity data is associated with legitimate user behavior or intruder behavior.

At a part 408, the trained AI model is imported to detect anomalous behavior in collected user features. As discussed herein, anomalies may correspond with sets of user activity data that the AI model either recognizes as being sufficiently dissimilar to user activity data of legitimate users, or does not recognize as being similar to user activity data of legitimate users (or both). Accordingly, anomalies may represent user behaviors that do not fall within the complex and/or complicated patterns of behavior that a model AI has been trained to learn. For example, if a force is used to open the door that is different than the force that a legitimate user would tend to use, or if an attempt to open the vehicle is made at a time of day that is different than a time of day at which a legitimate user would attempt to open the vehicle, the trained AI model may recognize the corresponding set of user activity data as being dissimilar to user activity data of legitimate users. Further details regarding analysis of collected user activity data using AI model for anomaly detection are described in relation to FIGS. 5-6.

At part 408, the trained AI model for anomaly detection may determine whether the user exhibits behavior of a legitimate user 410 or behavior of an intruder 412, based on collected user activity data (e.g., from part 402). As further described in relation to FIGS. 5-6, an action may be taken based on a determined identity of the user. If the user exhibits behavior of an intruder, method 400 may proceed to a part 414. If the user exhibits behavior of a legitimate user, method 400 may proceed to a part 416.

At part 416, if the user is identified as a legitimate user, the multi-layer security system may proceed from a layer n (e.g., the behavioral security layer) of the remote keyless system's security toward a layer n-1, a layer n-2, and so on, of the remote keyless system's security, which in various embodiments may include one or more cryptographic security layers. At a part 418, following any cryptographic security layers, the user may access the remote keyless system.

At part 414, if the user is determined to be an intruder, an event log may be recorded and/or an alert may be sent to one or more legitimate users (e.g., one or more users whose data was used to train the AI model according to method 300 of FIG. 3). As previously discussed, the behavioral security layer may include data corresponding to accesses of the remote keyless system by multiple users (for example, when a vehicle has multiple owners and/or operators), and as a result there may be multiple users who are classified as legitimate users during training. At part 416, a user determined to be an intruder may be allowed to access cryptographic security layers, and at part 418, the user determined to be an intruder may be allowed to access the remote keyless system.

In various embodiments, there may be some error pertaining to the AI model's determination as to whether a user is a legitimate user or an intruder (e.g., a 5% rate of making erroneous determinations, or another rate). Accordingly, in embodiments where the AI model erroneously determines that a legitimate user is an intruder, the legitimate user may still access the vehicle using other cryptographic security layers.

In various embodiments, new user behavior may be added to the dataset either before or after the training period. For example, in some embodiments, a dataset for a behavioral security layer may be transferred from a first vehicle to a second vehicle (e.g., a vehicle newly-acquired by the legitimate user(s)) before a training period has been completed in the second vehicle. Alternatively or additionally, a user who might otherwise be identified as an intruder may be added as a legitimate user, with approval from an existing legitimate user.

In one of a number of embodiments, using the behavioral analytics security layer to differentiate between a legitimate user and an intruder may be described as a method for determining whether user behavior is associated with behavior of a legitimate user. In other words, the method may include comparing user behavior to behaviors which have previously been identified as behaviors of a legitimate user, and attempt to identify whether sufficient similarities in behavior are present.

FIG. 5 shows a method 500 for performing an action based on a determination that a transmission for a remote keyless system of a vehicle (e.g., from a CID) is not associated with behavior of a legitimate user of the vehicle. Method 500 may be applied to a vehicle with a multi-layer security system, including a behavioral security layer. When a user who may or may not be a legitimate user attempts to access a vehicle, for example, by pressing a button on a CID (e.g., a key fob) or approaching the vehicle, a transmission may be sent to the vehicle. The transmission may be received by the vehicle over one of: a RF based link; or an IR based link.

At a part 502, method 500 includes processing the transmission for an operation of a remote keyless system with a behavioral security layer. In some embodiments, operation may be selected from a group including: a door lock operation; a door unlock operation; an engine start operation; an engine stop operation; an activate antitheft alarm operation; a deactivate antitheft alarm operation; and a panic-signal operation.

As described above, the remote keyless system may be implemented in a vehicle and may include at least one of RKE and RKI system capabilities. Embodiments of remote keyless system may include passive keyless (PK) systems, including passive keyless entry (PKE), passive keyless start (PKS), and passive keyless entry and start (PKES) systems. PKES systems may enable users to unlock and start their vehicles by possessing the CID in their pockets. Generally, PKES systems may use a challenge-response based security protocol between the vehicle and the CID, in which the vehicle periodically scans the CID to determine its proximity. When the CID acknowledges its proximity, the vehicle sends a challenge along with its ID and waits for the response of the CID. Upon a true response from the CID, the vehicle unlocks itself.

The behavioral security layer may include an AI model, such as an anomaly detection neural network, as discussed herein. In one of a number of embodiments, the AI model may be trained according to the method described in relation to FIG. 3. The AI model may thus be trained using one or more user behavioral parameters (e.g., the parameters described in relation to FIGS. 2-3) associated with behaviors corresponding with transmissions for operations of the remote keyless system. The transmission processed by the method 500 may include one or more user behavioral parameters of the sort used to train the AI model. For example, the transmission may include a time of day of the transmission, a date of the transmission, a location of the vehicle, a distance between the vehicle and a CID that transmitted the transmission, a number of times per day of operation of the CID, a time taken to open a door of the vehicle, a time taken to close the door, a force of opening the door, a force of closing the door, a temperature inside the vehicle, a temperature outside the vehicle, and/or a humidity.

At a part 504, method 500 includes determining whether the transmission is associated with behavior of a legitimate user of the vehicle, using the behavioral security layer. For example, the user behavioral parameters of the transmission may be analyzed by the AI model which has been trained to learn patterns of user behavioral parameters associated with legitimate users. Determining whether the transmission is associated with behavior of a legitimate user may include comparing user behavioral parameters of the transmission to a dataset of learned patterns. For example, the transmission may include a distance between the vehicle and a CID that transmitted the transmission. If the distance is different than a distance that the AI model associates with transmissions of legitimate users, the AI model may identify the transmission as not being associated with behavior of a legitimate user. In one of a number of embodiments, the transmission may include all of the aforementioned user behavioral parameters. If greater than a threshold number of user behavioral parameters (e.g., half of the user behavioral parameters) are determined to not be associated with behavior of a legitimate user, the AI model may identify the user as an intruder.

At a part 506 of method 500, if it is determined that the transmission is not associated with behavior of a legitimate user of the vehicle, method 500 may proceed to a part 508, and if it is determined that the transmission is associated with behavior of a legitimate user of the vehicle, method 500 may proceed to a part 510. At part 508, method 500 may include performing an action. The action may include generating an alert regarding the transmission and/or refraining from performing the operation. For example, the alert may be a notification sent to a smartphone or other device of one or more legitimate users of the vehicle.

As described above in FIGS. 1A-2, 4, the behavioral security layer may be one of a plurality of security layers of the remote keyless system. The plurality of security layers may further include one or more cryptographic security layers. In some embodiments, a user who has been identified by the AI model as an intruder may be able to access further security layers and attempt to access the vehicle. Thus, legitimate users who may have been erroneously identified as intruders by the behavioral analysis security layer may yet be able to access the remote keyless system. Alternatively, for some embodiments, a user who has been identified by the AI model as an intruder may be restricted from accessing further security layers (e.g., cryptographic security layers) of the remote keyless system.

At part 510, method 500 includes processing the transmission for the operation of the remote keyless system using remaining security layers of the plurality of security layers. When the plurality of security layers includes one or more cryptographic security layers, the one or more cryptographic security layers may be used to determine whether the transmission is legitimate after determining whether the transmission is associated with behavior of a legitimate user. For example, the one or more cryptographic security layers may analyze a code transmitted by a user to access the vehicle, as described above (as opposed to being analyzed by the AI model, which is for analyzing user behavior).

As discussed above, method 500 performs an action (e.g., generating an alert and/or refraining from performing the operation) based on a determination that a transmission from a CID is not associated with behavior of a legitimate user of the vehicle. Additionally, or alternatively, the trained AI model of the behavioral security layer may be used in a method where an action is performed based on identification of anomalous behavior in the user activity data by the AI model. For example, as discussed below, the action may be performed when a difference is identified rather than when a lack of similarity is identified.

FIG. 6 illustrates a method 600 for performing an action based on detection of anomalies in the behavior of an individual interacting with a remote keyless system. In method 600, a behavioral analytics model may be used to detect anomalous behavior in user activity data and thus differentiate between a legitimate user and an intruder. When anomalous behavior is detected, the user may be identified as an intruder and the method may perform a corresponding action.

At a part 602, when a user attempts to access a vehicle, such as by pressing a button on a CID (e.g., a key fob) or approaching the vehicle, the vehicle may receive a transmission to access a function of a remote keyless system of the vehicle. Functions of the remote keyless system may include locking one or more doors, unlocking one or more doors, starting an engine, stopping the engine, activating an antitheft alarm, deactivating the antitheft alarm, and/or operating a panic signal.

As described above, the remote keyless system may include a plurality of security layers, one of which is a behavioral security layer. At a part 604, method 600 may include analyzing a behavior corresponding with the transmission using a behavioral analytics model (e.g., a behavioral security layer as discussed herein). For example, the behavioral analytics model may be an AI model, such as an anomaly detection neural network. The behavioral analytics model may be an AI model trained using one or more parameters associated with behaviors corresponding with transmissions to access functions of the remote keyless system (e.g., as shown in FIG. 3). For example, the one or more parameters may include a time of day of the transmission, a date of the transmission, a location of the vehicle, a distance between the vehicle and a CID that transmitted the transmission, a number of times per day of operation of the CID, a time taken to open a door of the vehicle, a time taken to close the door, a force of opening the door, a force of closing the door, a temperature inside the vehicle, a temperature outside the vehicle, and/or a humidity. These parameters may reflect user behaviors in complex and/or complicated ways which may be different for a legitimate user compared to an intruder. The transmission may include all or a selection of the aforementioned parameters. The behavioral analytics model may analyze all of the parameters corresponding to the received transmission or a selection of the parameters.

Accordingly, analyzing the user behaviors may include performing anomaly detection analysis of all of the parameters corresponding to the received transmission or a selection of the parameters. For example, an anomaly may be a force of opening a door being different than a force of opening the door that the AI model associates with transmissions of legitimate users (e.g., learned by the behavioral analytics model to be associated with legitimate user behavior).

At a part 606, if an anomaly is not detected in behavior analysis, method 600 may proceed to a part 608, and if an anomaly is detected in behavior analysis, method 600 may proceed to a part 610. At part 608, method 600 may include analyzing the behavior (e.g., all or a selection of behaviors corresponding to the transmission) using cryptographic security layers. The one or more cryptographic security layers may be used to determine whether the transmission is legitimate after determining whether the transmission includes one or more anomalies. For example, the one or more cryptographic security layers may analyze a code transmitted by a user to access the vehicle, as described above (as opposed to being analyzed by the AI model, which is for analyzing user behavior).

At part 610, method 600 may include performing an action. The action may include generating an alert regarding the transmission and/or refraining from performing the function. For example, the alert may be a notification sent to a smartphone or other device of legitimate users which are coupled to the vehicle.

As described above in FIGS. 1A-2, 4, the behavioral security layer may be one of a plurality of security layers of the remote keyless system. The plurality of security layers may further include one or more cryptographic security layers. In some embodiments, a user who has been identified by the AI model as an intruder may be able to access further security layers and attempt to access the vehicle. Thus, legitimate users who may have been erroneously identified as intruders by the behavioral analysis security layer may yet be able to access the remote keyless system. Alternatively, for some embodiments, a user who has been identified by the AI model as an intruder may be restricted from accessing further security layers (e.g., cryptographic security layers) of the remote keyless system.

The behavioral security layer may be implemented in an embedded system of a vehicle, which may include a remote keyless system ECU. Additionally, or alternatively, the embedded system may include a processor with a digital cockpit ECU, a body control ECU, and so on, with a flashed firmware containing the behavioral analytics-based security method. Further details regarding a vehicle system in which the behavioral security layer may be implemented is described with respect to FIGS. 7-8.

Remote keyless systems may be unidirectional in transmission, with the transmission direction being from a CID to a vehicle. When a button is pressed on the CID, the CID may transmit a function code for the corresponding function of the remote keyless system (e.g., to unlock a door), depending upon which button is pressed. The receiver, after receiving the function code, may command hardware of the remote keyless system (e.g., in the vehicle) to take appropriate actions. Some of the remote access functions may include vehicle locking, vehicle unlocking, remote engine start, and/or activation of a panic signal (and other remote access functions disclosed herein). Thus, vehicles with a remote keyless system can be opened remotely with a push of a button on the CID or even without the CID, instead of insertion of a physical key.

FIG. 7 shows an example partial view of one type of environment for a security system including a behavioral security layer, as disclosed herein: an interior of a cabin 700 of a vehicle 702, in which a driver and/or one or more passengers may be seated. Vehicle 702 of FIG. 7 may be a motor vehicle including drive wheels (not shown) and an internal combustion engine 704. Internal combustion engine 704 may include one or more combustion chambers which may receive intake air via an intake passage and exhaust combustion gases via an exhaust passage. Vehicle 702 may be a road automobile, among other types of vehicles. In some examples, vehicle 702 may include a hybrid propulsion system including an energy conversion device operable to absorb energy from vehicle motion and/or the engine and convert the absorbed energy to an energy form suitable for storage by an energy storage device. Vehicle 702 may include a fully electric vehicle, incorporating fuel cells, solar energy capturing elements, and/or other energy storage systems for powering the vehicle.

As shown, an instrument panel 706 may include various displays and controls accessible to a human driver (also referred to as the user) of vehicle 702. For example, instrument panel 706 may include a touch screen 708 of an in-vehicle computing system 709 (e.g., an infotainment system), and an instrument cluster 710. In-vehicle computing system 709 may comprise a remote keyless system and/or elements of a security system including a behavioral security layer (as disclosed herein). Touch screen 708 may receive user input to in-vehicle computing system 709 for controlling the remote keyless system and/or elements of the security system including the behavioral security layer, audio output, visual display output, user preferences, control parameter selection, and so on. In some embodiments, one or more hardware elements of in-vehicle computing system 709, such as touch screen 708, a display screen 711, various control dials, knobs and buttons, memory, processor(s), and any interface elements (e.g., connectors or ports) may form an integrated head unit that is installed in instrument panel 706 of the vehicle. The head unit may be fixedly or removably attached in instrument panel 706. In additional or alternative embodiments, one or more hardware elements of in-vehicle computing system 709 may be modular and may be installed in multiple locations of the vehicle.

Cabin 700 may include one or more sensors for monitoring the vehicle, the user, and/or the environment. For example, cabin 700 may include one or more seat-mounted pressure sensors configured to measure the pressure applied to the seat to determine the presence of a user, door sensors configured to monitor door activity, humidity sensors to measure the humidity content of the cabin, microphones to receive user input in the form of voice commands, to enable a user to conduct telephone calls, and/or to measure ambient noise in cabin 700, and so on. It is to be understood that the above-described sensors and/or one or more additional or alternative sensors may be positioned in any suitable location of the vehicle. For example, sensors may be positioned in an engine compartment, on an external surface of the vehicle, and/or in other suitable locations for providing information regarding the operation of the vehicle, ambient conditions of the vehicle, a user of the vehicle, and so on. Information regarding ambient conditions of the vehicle, vehicle status, or vehicle driver may also be received from sensors external to/separate from the vehicle (that is, not part of the vehicle system), such as sensors coupled to external devices 750 and/or mobile device 728.

Cabin 700 may also include one or more user objects, such as a mobile device 728, that are stored in the vehicle before, during, and/or after travelling. Mobile device 728 may include a smart phone, a tablet, a laptop computer, a portable media player, and/or any suitable mobile computing device. Mobile device 728 may be connected to in-vehicle computing system via a communication link 730. Communication link 730 may be wired (e.g., via Universal Serial Bus (USB), Mobile High-Definition Link (MHL), High-Definition Multimedia Interface (HDMI), Ethernet, and so on) or wireless (e.g., via Bluetooth®, Wi-Fi®, Wi-Fi Direct®, Near-Field Communication (NFC), cellular connectivity, and so on) and configured to provide two-way communication between the mobile device and the in-vehicle computing system. (Bluetooth® is a registered trademark of Bluetooth SIG, Inc., Kirkland, WA. Wi-Fi® and Wi-Fi Direct® are registered trademarks of Wi-Fi Alliance, Austin, Texas.) Mobile device 728 may include one or more wireless communication interfaces for connecting to one or more communication links (e.g., one or more of the example communication links described above). The wireless communication interface may include one or more physical devices, such as antenna(s) or port(s) coupled to data lines for carrying transmitted or received data, as well as one or more modules/drivers for operating the physical devices in accordance with other devices in the mobile device. For example, communication link 730 may provide sensor and/or control signals from various vehicle systems (such as vehicle audio system, climate control system, and so on) and touch screen 708 to mobile device 728 and may provide control and/or display signals from mobile device 728 to the in-vehicle systems and touch screen 708. Communication link 730 may also provide power to mobile device 728 from an in-vehicle power source in order to charge an internal battery of the mobile device.

In-vehicle computing system 709 may also be communicatively coupled to additional devices operated and/or accessed by the user but located external to vehicle 702, such as one or more external devices 750. In the depicted embodiment, external devices are located outside of vehicle 702 though it will be appreciated that in alternate embodiments, external devices may be located inside cabin 700. The external devices may include a CID, server computing system, personal computing system, portable electronic device, electronic wrist band, electronic head band, portable music player, electronic activity tracking device, pedometer, smart-watch, GPS system, and so on. External devices 750 may be connected to the in-vehicle computing system via a communication link 736 which may be wired or wireless, as discussed with reference to communication link 730, and configured to provide two-way communication between the external devices and the in-vehicle computing system. For example, external devices 750 may include one or more sensors and communication link 736 may transmit sensor output from external devices 750 to in-vehicle computing system 709 and touch screen 708. External devices 750 may also store and/or receive information regarding contextual data, user behavior/preferences, operating rules, and so on and may transmit such information from external devices 750 to in-vehicle computing system 709 and touch screen 708.

In-vehicle computing system 709 may analyze the input received from external devices 750, mobile device 728, and/or other input sources and select settings for various in-vehicle systems (such as the remote keyless system and/or elements of the security system, including the behavioral security layer, or a climate control system, or an audio system), provide output via touch screen 708 and/or speakers 712, communicate with mobile device 728 and/or external devices 750, and/or perform other actions based on the assessment. Accordingly, in various embodiments, in-vehicle computing system 709 may include various portions of a vehicle receiver for receiving transmissions from a CID, as disclosed herein. In some embodiments, all or a portion of the assessment may be performed by mobile device 728 and/or external devices 750.

In some embodiments, one or more of external devices 750 may be communicatively coupled to in-vehicle computing system 709 indirectly, via mobile device 728 and/or another of external devices 750. For example, communication link 736 may communicatively couple external devices 750 to mobile device 728 such that output from external devices 750 is relayed to mobile device 728. Data received from external devices 750 may then be aggregated at mobile device 728 with data collected by mobile device 728, the aggregated data then transmitted to in-vehicle computing system 709 and touch screen 708 via communication link 730. Similar data aggregation may occur at a server system and then transmitted to in-vehicle computing system 709 and touch screen 708 via communication link 736 and/or communication link 730.

FIG. 8 shows a block diagram of in-vehicle computing system 709 configured and/or integrated inside vehicle 702. In-vehicle computing system 709 may perform one or more of the methods described herein in some embodiments, such as methods 400, 500, and/or 600. In various embodiments, in-vehicle computing system 709, or other components including an ECU of vehicle 702, may comprise one or more processors and a non-transitory memory having executable instructions that, when executed, may cause the one or more processors to carry out various parts of methods 400, 500, and/or 600. Accordingly, a security system including a behavioral layer as disclosed herein may be implemented using one or more processors and/or a memory of in-vehicle computing system 709 (or other components including an ECU of vehicle 702). In some examples, in-vehicle computing system 709 may be a vehicle infotainment system configured to provide information-based media content (audio and/or visual media content, including a security system including a behavioral security layer as disclosed herein, entertainment content, navigational services, and so on) to a vehicle user to enhance the operator's in-vehicle experience. In-vehicle computing system 709 may include, or be coupled to, various vehicle systems, sub-systems, hardware components, as well as software applications and systems that are integrated in, or integratable into, vehicle 702 in order to enhance an in-vehicle experience for a driver and/or a passenger.

In-vehicle computing system 709 may include one or more processors including an operating system processor 814 and an interface processor 820. Operating system processor 814 may execute an operating system on in-vehicle computing system 709, and control input/output, display, playback, and other operations of in-vehicle computing system 709. Interface processor 820 may interface with a vehicle control system 830 via an inter-vehicle system communication module 822.

Inter-vehicle system communication module 822 may output data to one or more other vehicle systems 831 and/or one or more other vehicle control elements 861, while also receiving data input from other vehicle systems 831 and other vehicle control elements 861, e.g., by way of vehicle control system 830. When outputting data, inter-vehicle system communication module 822 may provide a signal via a bus corresponding to any status of the vehicle, the vehicle surroundings, or the output of any other information source connected to the vehicle. Vehicle data outputs may include, for example, analog signals (such as current velocity), digital signals provided by individual information sources (such as clocks, thermometers, location sensors such as Global Positioning System (GPS) sensors, and so on), digital signals propagated through vehicle data networks (such as an engine controller area network (CAN) bus through which engine related information may be communicated, a climate control CAN bus through which climate control related information may be communicated, and a multimedia data network through which multimedia data is communicated between multimedia components in the vehicle). For example, in-vehicle computing system 709 may retrieve from the engine CAN bus the current speed of the vehicle estimated by the wheel sensors, a power state of the vehicle via a battery and/or power distribution system of the vehicle, an ignition state of the vehicle, and so on. In addition, other interfacing means such as Ethernet may be used as well without departing from the scope of this disclosure.

A storage device 808 may be included in in-vehicle computing system 709 to store data such as instructions executable by operating system processor 814 and/or interface processor 820 in non-volatile form. Storage device 808 may store application data, including prerecorded sounds, to enable in-vehicle computing system 709 to run an application for connecting to a cloud-based server and/or collecting information for transmission to the cloud-based server. The application may retrieve information gathered by vehicle systems/sensors, input devices (e.g., a user interface 818), data stored in one or more storage devices, such as a volatile memory 819A or a non-volatile memory 819B, devices in communication with the in-vehicle computing system (e.g., a mobile device connected via a Bluetooth® link), and so on. In-vehicle computing system 709 may further include a volatile memory 819A. Volatile memory 819A may be random access memory (RAM). Non-transitory storage devices, such as non-volatile storage device 808 and/or non-volatile memory 819B, may store instructions and/or code that, when executed by a processor (e.g., operating system processor 814 and/or interface processor 820), controls in-vehicle computing system 709 to perform one or more of the actions described in the disclosure.

A microphone 802 may be included in in-vehicle computing system 709 to receive voice commands from a user, to measure ambient noise in the vehicle, to determine whether audio from speakers of the vehicle is tuned in accordance with an acoustic environment of the vehicle, and so on. A speech processing unit 804 may process voice commands, such as the voice commands received from microphone 802. In some embodiments, in-vehicle computing system 709 may also be able to receive voice commands and sample ambient vehicle noise using a microphone included in an audio system 832 of the vehicle.

One or more additional sensors may be included in a sensor subsystem 810 of in-vehicle computing system 709. For example, sensor subsystem 810 may include a camera, such as a rear view camera for assisting a user in parking the vehicle and/or a cabin camera for identifying a user (e.g., using facial recognition and/or user gestures). Sensor subsystem 810 of in-vehicle computing system 709 may communicate with and receive inputs from various vehicle sensors and may further receive user inputs. For example, the inputs received by sensor subsystem 810 may include transmission gear position, transmission clutch position, gas pedal input, brake input, transmission selector position, vehicle speed, engine speed, mass airflow through the engine, ambient temperature, intake air temperature, and so on, as well as inputs from climate control system sensors (such as heat transfer fluid temperature, antifreeze temperature, fan speed, passenger compartment temperature, desired passenger compartment temperature, ambient humidity, and so on), an audio sensor detecting voice commands issued by a user, a CID sensor receiving transmissions from, and optionally tracking the geographic location and/or proximity of, a CID of a remote keyless system of the vehicle, and so on.

While certain vehicle system sensors may communicate with sensor subsystem 810 alone, other sensors may communicate with both sensor subsystem 810 and vehicle control system 830, or may communicate with sensor subsystem 810 indirectly via vehicle control system 830. A navigation subsystem 811 of in-vehicle computing system 709 may generate and/or receive navigation information such as location information (e.g., via a GPS sensor and/or other sensors from sensor subsystem 810), route guidance, traffic information, point-of-interest (POI) identification, and/or provide other navigational services for the driver.

An external device interface 812 of in-vehicle computing system 709 may be coupleable to and/or communicate with one or more external devices 750 located external to vehicle 702. While the external devices are illustrated as being located external to vehicle 702, it is to be understood that they may be temporarily housed in vehicle 702, such as when the user is operating the external devices while operating vehicle 702. In other words, external devices 750 are not integral to vehicle 702. External devices 750 may include a mobile device 728 (e.g., connected via a Bluetooth®, NFC, WI-FI Direct®, or other wireless connection) or an alternate Bluetooth®-enabled device 852.

Mobile device 728 may be a mobile phone, smart phone, wearable devices/sensors that may communicate with the in-vehicle computing system via wired and/or wireless communication, or other portable electronic device(s). Other external devices include one or more external services 846. For example, the external devices may include extra-vehicular devices that are separate from and located externally to the vehicle. Still other external devices include one or more external storage devices 854, such as solid-state drives, pen drives, Universal Serial Bus (USB) drives, and so on. External devices 750 may communicate with in-vehicle computing system 709 either wirelessly or via connectors without departing from the scope of this disclosure. For example, external devices 750 may communicate with in-vehicle computing system 709 through external device interface 812 over a network 860, a USB connection, a direct wired connection, a direct wireless connection, and/or other communication link.

External device interface 812 may provide a communication interface to enable the in-vehicle computing system to communicate with mobile devices associated with contacts of the driver. For example, external device interface 812 may enable phone calls to be established and/or text messages (e.g., Short Message Service (SMS), Multimedia Message Service (MMS), and so on) to be sent (e.g., via a cellular communications network) to a mobile device associated with a contact of the driver. External device interface 812 may additionally, or alternatively, provide a wireless communication interface to enable the in-vehicle computing system to synchronize data with one or more devices in the vehicle (e.g., the driver's mobile device) via Wi-Fi Direct®, as described in more detail below.

One or more applications 844 may be operable on mobile device 728. As an example, a mobile device application 844 may be operated to aggregate user data regarding interactions of the user with the mobile device. For example, mobile device application 844 may aggregate data regarding music playlists listened to by the user on the mobile device, telephone call logs (including a frequency and duration of telephone calls accepted by the user), positional information including locations frequented by the user and an amount of time spent at each location, and so on. The collected data may be transferred by application 844 to external device interface 812 over network 860. In addition, specific user data requests may be received at mobile device 728 from in-vehicle computing system 709 via external device interface 812. The specific data requests may include requests for determining where the user is geographically located, an ambient noise level and/or music genre at the user's location, an ambient weather condition (temperature, humidity, and so on) at the user's location, and so on. Mobile device application 844 may send control instructions to components (e.g., microphone, amplifier, and so on) or other applications (e.g., navigational applications) of mobile device 728 to enable the requested data to be collected on the mobile device or requested adjustment made to the components. Mobile device application 844 may then relay the collected information back to in-vehicle computing system 709.

Likewise, one or more applications 848 may be operable on external services 846. As an example, external services applications 848 may be operated to aggregate and/or analyze data from multiple data sources. For example, external services applications 848 may aggregate data from one or more social media accounts of the user, data from the in-vehicle computing system (e.g., sensor data, log files, user input, and so on), data from an internet query (e.g., weather data, POI data), and so on. The collected data may be transmitted to another device and/or analyzed by the application to determine a context of the driver, vehicle, and environment and perform an action based on the context (e.g., requesting/sending data to other devices).

Vehicle control system 830 may include controls for controlling aspects of various vehicle systems 831 involved in different in-vehicle functions. These may include, for example, controlling aspects of vehicle audio system 832 for providing audio entertainment to the vehicle occupants, aspects of a climate control system 834 for meeting the cabin cooling or heating needs of the vehicle occupants, as well as aspects of a telecommunication system 836 for enabling vehicle occupants to establish telecommunication linkage with others.

Audio system 832 may include one or more acoustic reproduction devices including electromagnetic transducers such as one or more speakers 835. Vehicle audio system 832 may be passive or active such as by including a power amplifier. In some examples, in-vehicle computing system 709 may be a sole audio source for the acoustic reproduction device or there may be other audio sources that are connected to the audio reproduction system (e.g., external devices such as a mobile phone). The connection of any such external devices to the audio reproduction device may be analog, digital, or any combination of analog and digital technologies.

Climate control system 834 may be configured to provide a comfortable environment within the cabin or passenger compartment of vehicle 702. Climate control system 834 includes components enabling controlled ventilation such as air vents, a heater, an air conditioner, an integrated heater and air-conditioner system, and so on. Other components linked to the heating and air-conditioning setup may include a windshield defrosting and defogging system capable of clearing the windshield and a ventilation-air filter for cleaning outside air that enters the passenger compartment through a fresh-air inlet.

Vehicle control system 830 may also include controls for adjusting the settings of various vehicle control elements 861 (or vehicle controls, or vehicle system control elements) related to the engine and/or auxiliary elements within a cabin of the vehicle, such as one or more steering wheel controls 862 (e.g., steering wheel-mounted audio system controls, cruise controls, windshield wiper controls, headlight controls, turn signal controls, and so on), instrument panel controls, microphone(s), accelerator/brake/clutch pedals, a gear shift, door/window controls positioned in a driver or passenger door, seat controls, cabin light controls, audio system controls, cabin temperature controls, and so on. Vehicle control elements 861 may also include internal engine and vehicle operation controls (e.g., engine controller module, actuators, valves, and so on) that are configured to receive instructions via the CAN bus of the vehicle to change operation of one or more of the engine, exhaust system, transmission, and/or other vehicle system. The control signals may also control audio output at one or more speakers 835 of vehicle audio system 832. For example, the control signals may adjust audio output characteristics such as volume, equalization, audio image (e.g., the configuration of the audio signals to produce audio output that appears to a user to originate from one or more defined locations), audio distribution among a plurality of speakers, and so on. Likewise, the control signals may control vents, air conditioner, and/or heater of climate control system 834. For example, the control signals may increase delivery of cooled air to a specific section of the cabin.

Control elements positioned on an outside of a vehicle (e.g., controls for a security system) may also be connected to in-vehicle computing system 709, such as via inter-vehicle system communication module 822. The control elements of vehicle control system 830 may be physically and permanently positioned on and/or in the vehicle for receiving user input. In addition to receiving control instructions from in-vehicle computing system 709, vehicle control system 830 may also receive input from one or more external devices 750 operated by the user, such as from mobile device 728. This allows aspects of vehicle systems 831 and vehicle control elements 861 to be controlled based on user input received from external devices 750.

In-vehicle computing system 709 may further include one or more antennas 806. The in-vehicle computing system may obtain broadband wireless internet access via antennas 806, and may further receive broadcast signals such as radio, television, weather, traffic, and the like. In-vehicle computing system 709 may receive positioning signals such as GPS signals via antennas 806. The in-vehicle computing system may also receive wireless commands via RF such as via antennas 806 or via IR or other means through appropriate receiving devices. In some embodiments, antenna 806 may be included as part of audio system 832 or telecommunication system 836. Additionally, antenna 806 may provide AM/FM radio signals to external devices 750 (such as to mobile device 728) via external device interface 812.

One or more elements of in-vehicle computing system 709 may be controlled by a user via user interface 818. User interface 818 may include a graphical user interface presented on a touch screen, such as touch screen 708 and/or display screen 711 of FIG. 7, and/or user-actuated buttons, switches, knobs, dials, sliders, and so on. For example, user-actuated elements may include steering wheel controls, door and/or window controls, instrument panel controls, audio system settings, climate control system settings, and the like. A user may also interact with one or more applications of in-vehicle computing system 709 and mobile device 728 via user interface 818. In addition to receiving a user's vehicle setting preferences on user interface 818, vehicle settings selected by in-vehicle control system 830 may be displayed to a user on user interface 818. Notifications and other messages (e.g., received messages), as well as navigational assistance, may be displayed to the user on a display of the user interface 818. User preferences/information and/or responses to presented messages may be performed via user input to the user interface 818.

As discussed herein, security of a remote keyless system of a vehicle, and thus internal components of the vehicle, may be increased using a behavioral security layer. Behavioral parameters of users attempting to access the vehicle via the remote keyless system may be analyzed by an AI model trained to detect anomalies in user behaviors. Upon determination by the AI model that behaviors of the user are not associated with behavior of a legitimate user and/or identification of anomalies in the user activity data (e.g., including behavioral parameters) by the AI model, an action may be performed. For example, the action may include generating an alert regarding attempted access to the vehicle, refraining from allowing access to cryptographic security layers, and/or allowing access to cryptographic security layers.

The disclosure also provides support for a method comprising: processing a transmission for an operation of a remote keyless system of a vehicle, the remote keyless system having a behavioral security layer, determining whether the transmission is associated with behavior of a legitimate user of the vehicle, by using the behavioral security layer, and performing an action based on a determination that the transmission is not associated with the behavior of the legitimate user of the vehicle. In a first example of the method, the action includes at least one of: generating an alert regarding the transmission, and refraining from performing the operation. In a second example of the method, optionally including the first example, the behavioral security layer includes an artificial intelligence model that has been trained using one or more behavioral parameters associated with behaviors corresponding with transmissions for operations of the remote keyless system. In a third example of the method, optionally including one or both of the first and second examples, the behavioral parameters include at least a predetermined number of parameters selected from a set of parameters including: a time of day of the transmission, a date of the transmission, a location of the vehicle, a distance between the vehicle and a CID that transmitted the transmission, a number of times per day of operation of the CID, a time taken to open a door of the vehicle, a time taken to close the door, a force of opening the door, a force of closing the door, a temperature inside the vehicle, a temperature outside the vehicle, and a humidity. In a fourth example of the method, optionally including one or more or each of the first through third examples, the behavioral parameters include all parameters of the set of parameters. In a fifth example of the method, optionally including one or more or each of the first through fourth examples, the behavioral security layer is one of a plurality of security layers of the remote keyless system. In a sixth example of the method, optionally including one or more or each of the first through fifth examples, the plurality of security layers includes one or more cryptographic security layers. In a seventh example of the method, optionally including one or more or each of the first through sixth examples, the one or more cryptographic security layers are used to determine whether the transmission is legitimate after determining whether the transmission is associated with anomalous behavior. In an eighth example of the method, optionally including one or more or each of the first through seventh examples, the remote keyless system includes at least one of: a remote keyless entry system, and a remote keyless ignition system. In a ninth example of the method, optionally including one or more or each of the first through eighth examples, the operation is selected from a group including: a door lock operation, a door unlock operation, an engine start operation, an engine stop operation, an activate antitheft alarm operation, a deactivate antitheft alarm operation, and a panic-signal operation. In a tenth example of the method, optionally including one or more or each of the first through ninth examples, the transmission is received over one of: a RF based link, or an IR based link.

The disclosure also provides support for a method of securing access to a vehicle, the method comprising: receiving a transmission to access a function of a remote keyless system of the vehicle, the remote keyless system having a plurality of security layers including a behavioral security layer, analyzing a behavior corresponding with the transmission using a behavioral analytics model, and performing an action based on the step of analyzing the behavior to detect an anomaly in the behavior, wherein the behavioral analytics model has been trained using one or more parameters associated with behaviors corresponding with transmissions to access functions of the remote keyless system. In a first example of the method, the action includes at least one of: generating an alert regarding the transmission, and refraining from performing the function. In a second example of the method, optionally including the first example, the parameters associated with behaviors include at least a predetermined number of parameters selected from a set of parameters including: a time of day of the transmission, a date of the transmission, a location of the vehicle, a distance between the vehicle and a CID that transmitted the transmission, a number of times per day of operation of the CID, a time taken to open a door of the vehicle, a time taken to close the door, a force of opening the door, a force of closing the door, a temperature inside the vehicle, a temperature outside the vehicle, and a humidity. In a third example of the method, optionally including one or both of the first and second examples, the plurality of security layers includes one or more cryptographic security layers, and wherein the one or more cryptographic security layers are used to determine whether the transmission is legitimate after determining whether the transmission is associated with anomalous behavior.

The disclosure also provides support for a remote keyless system for a vehicle, comprising: one or more processors, and a non-transitory memory having executable instructions that, when executed, cause the one or more processors to: receive a transmission for an operation of the remote keyless system, conduct an analysis of a behavior associated with the transmission using a behavioral analytics model, and based on a set of parameters of the behavior, determine, based on the analysis of the behavior, whether the behavior is not associated with a legitimate user of the vehicle, and perform an action, based on determination that the behavior is not associated with the legitimate user of the vehicle, including at least one of: generate an alert regarding the operation, and refrain from performing the operation, wherein the behavioral analytics model has been trained using at least a predetermined number of the following behavioral parameters: a time of day of the transmission, a date of the transmission, a location of the vehicle, a distance between the vehicle and a CID that transmitted the transmission, a number of times per day of operation of the CID, a time taken to open a door of the vehicle, a time taken to close the door, a force of opening the door, a force of closing the door, a temperature inside the vehicle, a temperature outside the vehicle, and a humidity. In a first example of the system, the one or more processors include at least one ECU of the vehicle, and wherein the non-transitory memory includes one or more non-volatile storage devices. In a second example of the system, optionally including the first example, a plurality of security layers includes one or more cryptographic security layers, and wherein the one or more cryptographic security layers are used to determine whether the transmission is legitimate after determining whether the transmission is associated with anomalous behavior. In a third example of the system, optionally including one or both of the first and second examples, the remote keyless system is integrated in an in-vehicle computing system. In a fourth example of the system, optionally including one or more or each of the first through third examples, the in-vehicle computing system includes various portions of a vehicle receiver for receiving transmissions from at least one external device.

The description of embodiments has been presented for purposes of illustration and description. Suitable modifications and variations to the embodiments may be performed in light of the above description or may be acquired from practicing the methods. For example, unless otherwise noted, one or more of the described methods may be performed by a suitable device and/or combination of devices. The methods may be performed by executing stored instructions with one or more logic devices (e.g., processors) in combination with one or more additional hardware elements, such as storage devices, memory, hardware network interfaces and/or antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used in this application, an element or step recited in the singular and preceded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” and so on. are used merely as labels, and are not intended to impose numerical requirements or a particular positional order on their objects. As used herein, terminology in which elements are presented in a list using “and/or” language means any combination of the listed elements. For example, “A, B, and/or C” may mean any of the following: A alone; B alone; C alone; A and B; A and C; B and C; or A, B, and C. The following claims particularly point out subject matter from the above disclosure that is regarded as novel and non-obvious.

1. A method comprising:
processing a transmission for an operation of a remote keyless system of a vehicle, the remote keyless system having a behavioral security layer;
determining whether the transmission is associated with behavior of a legitimate user of the vehicle, by using the behavioral security layer; and
performing an action based on a determination that the transmission is not associated with the behavior of the legitimate user of the vehicle.

2. The method of claim 1, wherein the action includes at least one of: generating an alert regarding the transmission; and refraining from performing the operation.

3. The method of claim 1, wherein the behavioral security layer includes an artificial intelligence model that has been trained using one or more behavioral parameters associated with behaviors corresponding with transmissions for operations of the remote keyless system.

4. The method of claim 3, wherein the behavioral parameters include at least a predetermined number of parameters selected from a set of parameters including: a time of day of the transmission; a date of the transmission; a location of the vehicle; a distance between the vehicle and a customer identification device (CID) that transmitted the transmission; a number of times per day of operation of the CID; a time taken to open a door of the vehicle; a time taken to close the door; a force of opening the door; a force of closing the door; a temperature inside the vehicle; a temperature outside the vehicle; and a humidity.

5. The method of claim 4, wherein the behavioral parameters include all parameters of the set of parameters.

6. The method of claim 1, wherein the behavioral security layer is one of a plurality of security layers of the remote keyless system.

7. The method of claim 6, wherein the plurality of security layers includes one or more cryptographic security layers.

8. The method of claim 7, wherein the one or more cryptographic security layers are used to determine whether the transmission is legitimate after determining whether the transmission is associated with anomalous behavior.

9. The method of claim 1, wherein the remote keyless system includes at least one of: a remote keyless entry system; and a remote keyless ignition system.

10. The method of claim 1, wherein the operation is selected from a group including: a door lock operation; a door unlock operation; an engine start operation; an engine stop operation; an activate antitheft alarm operation; a deactivate antitheft alarm operation; and a panic-signal operation.

11. The method of claim 1, wherein the transmission is received over one of: a radio frequency (RF) based link; or an infrared (IR) based link.

12. A method of securing access to a vehicle, the method comprising:
receiving a transmission to access a function of a remote keyless system of the vehicle, the remote keyless system having a plurality of security layers including a behavioral security layer;
analyzing a behavior corresponding with the transmission using a behavioral analytics model; and
performing an action based on the step of analyzing the behavior to detect an anomaly in the behavior,
wherein the behavioral analytics model has been trained using one or more parameters associated with behaviors corresponding with transmissions to access functions of the remote keyless system.

13. The method of securing access to the vehicle of claim 12, wherein the action includes at least one of: generating an alert regarding the transmission; and refraining from performing the function.

14. The method of securing access to the vehicle of claim 12, wherein the parameters associated with behaviors include at least a predetermined number of parameters selected from a set of parameters including: a time of day of the transmission; a date of the transmission; a location of the vehicle; a distance between the vehicle and a customer identification device (CID) that transmitted the transmission; a number of times per day of operation of the CID; a time taken to open a door of the vehicle; a time taken to close the door; a force of opening the door; a force of closing the door; a temperature inside the vehicle; a temperature outside the vehicle; and a humidity.

15. The method of securing access to the vehicle of claim 12,
wherein the plurality of security layers includes one or more cryptographic security layers; and
wherein the one or more cryptographic security layers are used to determine whether the transmission is legitimate after determining whether the transmission is associated with anomalous behavior.

16. A remote keyless system for a vehicle, comprising:
one or more processors; and
a non-transitory memory having executable instructions that, when executed, cause the one or more processors to:
receive a transmission for an operation of the remote keyless system;
conduct an analysis of a behavior associated with the transmission using a behavioral analytics model, and based on a set of parameters of the behavior;
determine, based on the analysis of the behavior, whether the behavior is not associated with a legitimate user of the vehicle; and
perform an action, based on determination that the behavior is not associated with the legitimate user of the vehicle, including at least one of: generate an alert regarding the operation; and refrain from performing the operation,
wherein the behavioral analytics model has been trained using at least a predetermined number of the following behavioral parameters: a time of day of the transmission; a date of the transmission; a location of the vehicle; a distance between the vehicle and a customer identification device (CID) that transmitted the transmission; a number of times per day of operation of the CID; a time taken to open a door of the vehicle; a time taken to close the door; a force of opening the door; a force of closing the door; a temperature inside the vehicle; a temperature outside the vehicle; and a humidity.

17. The remote keyless system of claim 16, wherein the one or more processors include at least one electronic control unit (ECU) of the vehicle; and
wherein the non-transitory memory includes one or more non-volatile storage devices.

18. The remote keyless system of claim 16,
wherein a plurality of security layers includes one or more cryptographic security layers; and
wherein the one or more cryptographic security layers are used to determine whether the transmission is legitimate after determining whether the transmission is associated with anomalous behavior.

19. The remote keyless system of claim 16, wherein the remote keyless system is integrated in an in-vehicle computing system.

20. The remote keyless system of claim 19, wherein the in-vehicle computing system includes various portions of a vehicle receiver for receiving transmissions from at least one external device.
